(19) United States
(12) Patent Application Publication
(10) Pub. No.: US 2015/0209741 A1
(43) Pub. Date: Jul. 30, 2015

(54) Polymer Mixer

(71) Applicant: ProMinent Fluid Controls, Inc., Pittsburgh, PA (US)

(72) Inventors: Ralph Leavelle Morrison, Momence, IL (US); Glen John Seifert, Pittsburgh, PA (US); John M. Strack, Bethel Park, PA (US); Edward J. Thomas, Yardville, NJ (US)

(21) Appl. No.: 14/606,560

(22) Filed: Jan. 27, 2015

Related U.S. Application Data
(60) Provisional application No. 61/931,972, filed on Jan. 27, 2014.

(51) Int. Cl. B01F 7/00; B01F 3/08; B01F 15/00

(52) U.S. Cl. CPC B01F 7/00491; B01F 15/00538; B01F 3/0857; B01F 2215/0049; B01F 2003/0896; B01F 2003/0884

(57) ABSTRACT

A polymer mixer comprising an impeller formed from a series of rotating discs mounted to a drive shaft and driven by an electric motor. Polymer is piped through a mixing chamber to the inlet of the rotating discs that creates a high shear mixing zone. Dilution water is also piped to the high shear mixing zone which is a concentric hole in the center of the discs which serves as a liquid inlet when the discs are spinning. The discs are in close proximity creating high velocity and turbulence via centrifugal force. An open design between the discs allows the disc surface to pass the solution molecules multiple times before the molecules exit the perimeter, creating a shearing affect by the high speed surface in the solution. Discs of smaller diameter are coupled to the high shear discs to further mix and recirculate more viscous solutions.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 61/931,972, entitled “POLYMER MIXER”, filed Jan. 27, 2014. The contents of the above referenced application is incorporated herein by reference.

### FIELD OF THE INVENTION

This invention is related to the field of mixing devices and in particular to a polymer mixer impeller.

### BACKGROUND OF THE INVENTION

Water soluble polymers are used industry wide to aid in water/solids separation processes. Polymers are long chain carbon-carbon molecules bonded to various functional groups to provide charge sites along the length of the polymer chain. These charge sites attract and hold small particles of opposite charge, combining them into a much larger particle. This process is known as flocculation wherein the aggregation of dispersed and colloidal matter is promote by adding the polymer to form larger sized “flocs” which can be removed by filtration or settling. The floc created is easier to filter/separate, making the liquid solid separation process more efficient.

Most commercially available polymers require mixing/activating with water, on site, before they can be used. The nature of these polymers requires high shear mixing energy when first introduced to water. This insures all the polymer molecules get exposed to the water, and prevents agglomerations of the polymer molecules, both prevent waste.

Once exposed to water, the long chain molecules begin to uncoil to expose the active charge sites. The uncoiled molecules become shear sensitive and can be damaged by further high shear mixing energy. Low shear agitation following the high shear initial wetting allows polymer molecules to fully uncoil without being damaged.

What is needed in the industry is a polymer mixer capable of providing a high shear initial mixing energy via rotating circular discs.

### SUMMARY OF THE INVENTION

Disclosed is a polymer mixer capable of providing high shear mixing energy. The impeller of the instant polymer mixer is a series of discs mounted to a rotating shaft. Polymer is piped through a mixing chamber into an inlet of a high shear mixing zone to control exposure to the dilution water. The dilution water is also piped to the high shear mixing zone. The polymer and dilution water are directed to the center of the discs which have a concentric hole in the center which serves as a liquid inlet when the discs are spinning. The discs are in close proximity creating high velocity and turbulence via centrifugal force.

An objective of the instant invention is to disclose a polymer mixer capable of providing high shear initial mixing energy.

Still another objective of the instant invention is to disclose a polymer mixing impeller formed from a series of discs mounted having a concentric hole in the center which serves a polymer and dilution water inlet while the discs are spinning.

Yet still another objective of the instant invention is to disclose a polymer mixing impeller wherein a series of discs are in close proximity to create high velocity and turbulence via centrifugal force.

Still another objective of the instant invention is to disclose a polymer mixing impeller having an open design between the discs allowing disc surface passage during rotation to create a shearing effect on the polymer.

Another objective of the instant invention is to disclose a polymer mixing impeller having discs of smaller diameter constructed and arranged to provide a tip speed of about 60 ft/sec and larger discs constructed and arrange to provide tip speed of about 90 ft/sec.

Yet still another objective of the instant invention is to disclose a polymer mixing impeller wherein discs further mix and recirculate viscous maturing solution with lower energy to prevent shear damage.

The polymer injection piping is equipped with an annular discharge spring loaded check valve. This valve causes the polymer to discharge in a very thin annular pattern, which maximizes surface contact with the dilution water.

Other objectives and further advantages and benefits associated with this invention will be apparent to those skilled in the art from the description, examples and claims which follow.

### BRIEF DESCRIPTION OF THE DRAWINGS

FIG. 1 is a pictorial cross sectional view of the mixing impeller;

FIG. 2 is a pictorial cross sectional view of the mixing impeller depicting flows;

FIG. 3 is a perspective view of the mixing impeller;

FIG. 4 is a cross sectional view of the mixing impeller within a housing;

FIG. 5A is a front view of the primary disc;

FIG. 5B is a side view of the primary disc;

FIG. 6 is a front perspective view of a multi chamber primary disc;

FIG. 7 is a rear perspective view FIG. 6;

FIG. 8A is a front view of the secondary disc;

FIG. 8B is a side view of the secondary disc; and

FIG. 9 is a pictorial cross section view of the present invention.

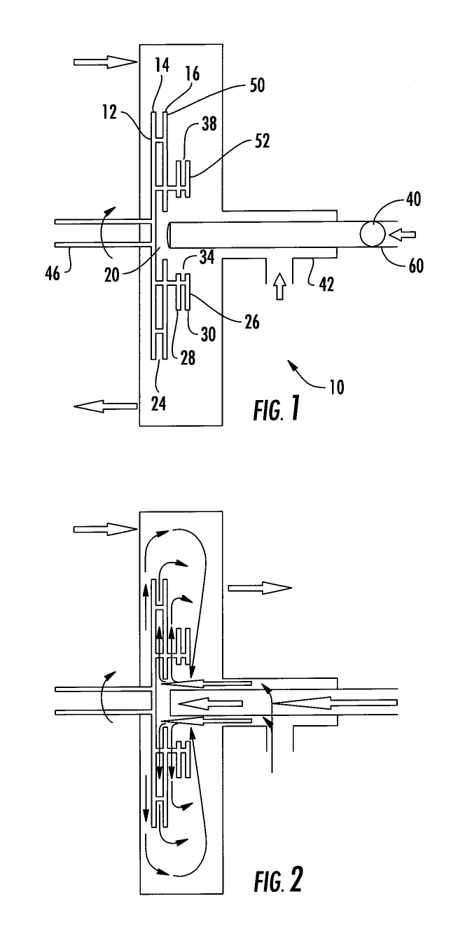

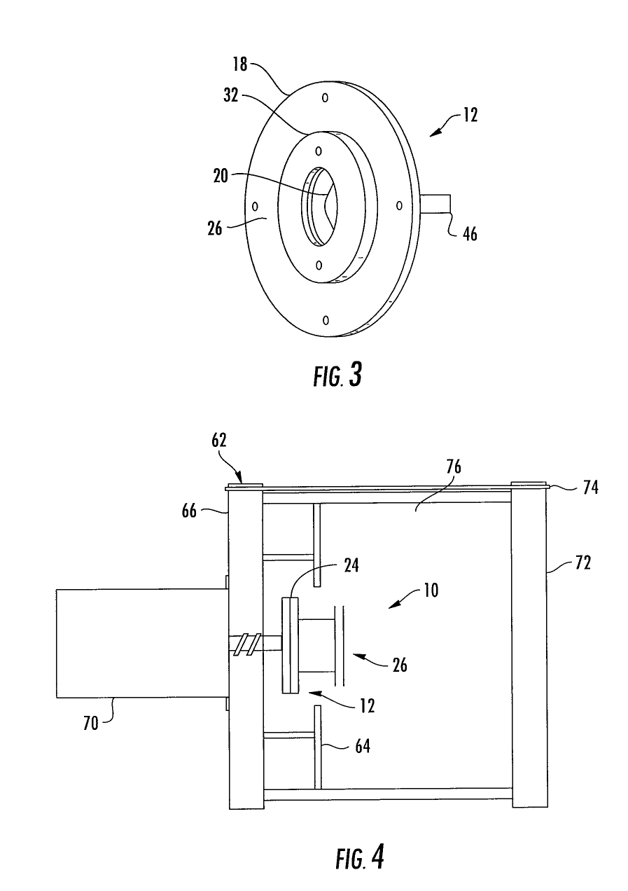

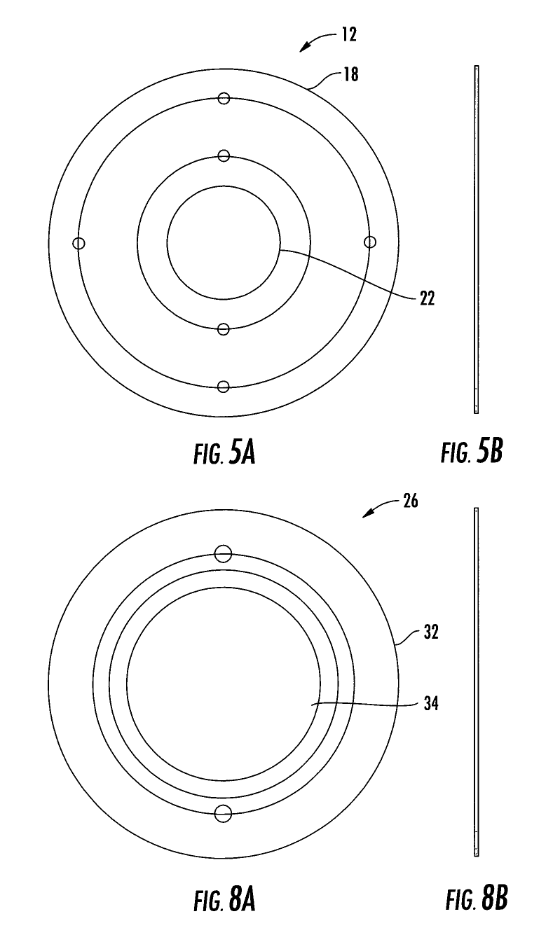

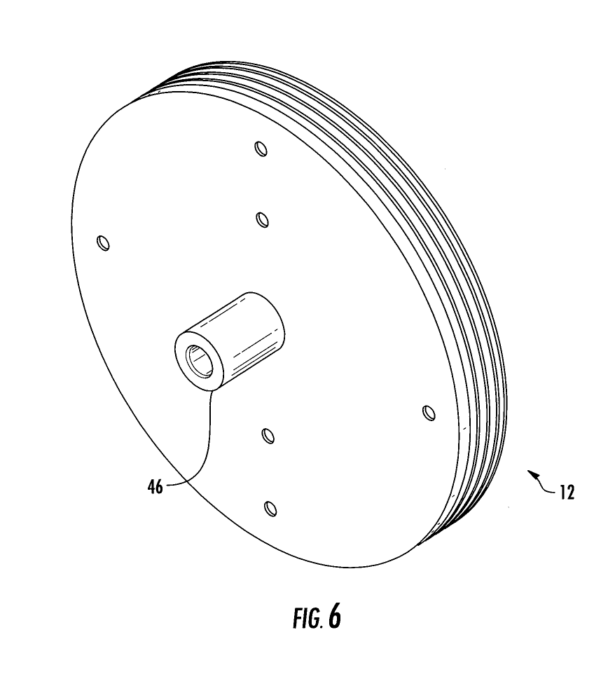

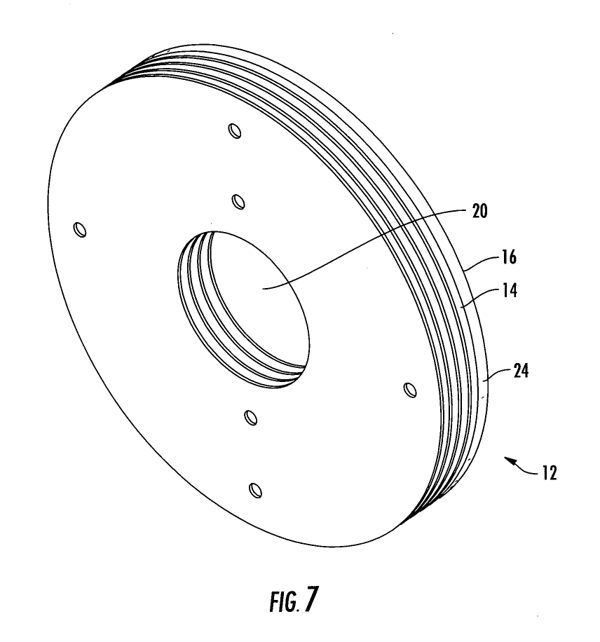

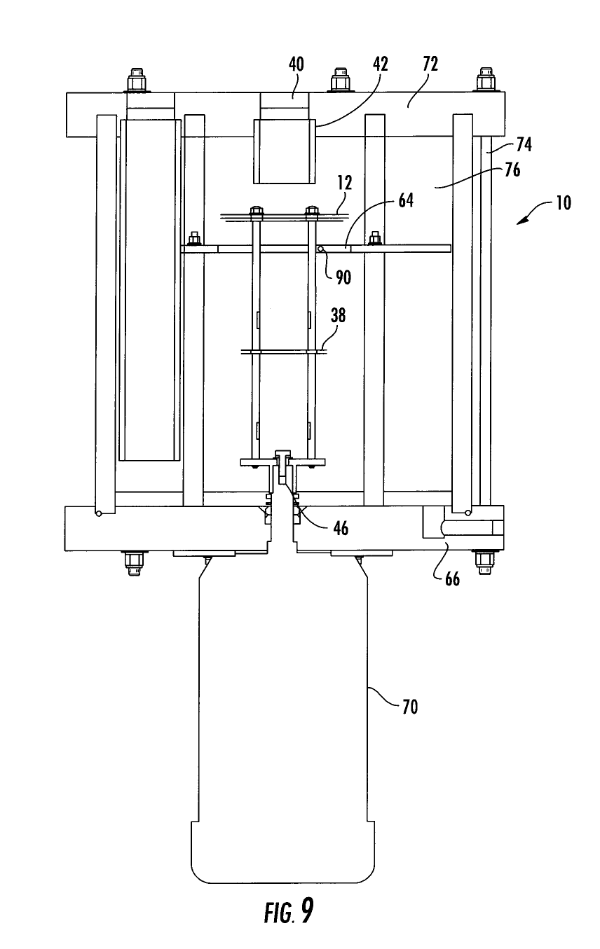

### DETAILED DESCRIPTION OF THE PREFERRED EMBODIMENT

Referring now to the Figures, disclosed is a polymer mixing impeller 10 capable of providing a high shear initial mixing energy. The polymer mixer has a high shear member 12 constructed from two spaced apart circular primary discs 14, 16 having an outer diameter 18 and a first inlet 20 formed along an inner diameter 22 with a high shear chamber 24 formed therebetween. A low shear member 26 is constructed from two spaced apart circular secondary discs 28, 30 having an outer diameter 32 and a second inlet 34 formed along an inner diameter of the secondary disc with a low shear chamber 38 formed therebetween. A first injection pipe 40 is used for introducing polymer into the first inlet 20 of the primary discs 14, 16. A second injection pipe 42 is used for introducing dilution water into the first inlet of 20 of the primary discs 14, 16. A drive shaft 46 is coupled to the high shear member 12 and low shear member 26 for rotation. The injection of polymer and dilution water into the inlet 20 of the primary discs 14, 16 during rotation forms an admixture subject to high shear mixing and recirculated into the second inlet 34 of the second discs 28, 30 low shear mixing of the admixture.

The mixing impeller is a series of rotating discs mounted to the drive motor shaft 46 of an electric motor 70 operating at a conventional 3450 rpm. Polymer is piped through the mixing chamber to the inlet 20 of the high shear mixing zone, preventing any exposure to the dilution water. The dilution water is also piped to the inlet 20 of the high shear mixing zone. The polymer and dilution water are then directed to the center of the discs which have a concentric hole in the center which serves as a liquid inlet when the discs are spinning. The discs are in close proximity creating high velocity and turbulence via centrifugal force.

Open design between the discs creates a high shear chamber 24 and a low shear chamber 38, wherein the admixture solution molecules passes multiple times before the molecules exit the perimeter, creating a shearing affect by the high speed surface in the solution. Discs of smaller diameter and larger inlet are coupled to the high shear discs to further mix and recirculate the more viscous maturing solution with lower energy to prevent shear damage.

In operation, polymer and water are combined at the center of the discs. The disc travels further in same amount of time as it gets larger in diameter, in one iteration the velocities would be 90 ft/sec. While the discs are spinning, polymer and water are introduced in an annular pattern, into the annular inlet of the high shear mixing discs where the solution molecules experience a sudden increase in velocity as they traveled outward through the discs. Upon exiting the high shear mixing zone, the solution is drawn back toward the mixer inlet, where it gets recirculated through the low shear discs before exiting.

The polymer mixer has an outer diameter 18 of the primary disc member 12 being greater than the outer diameter 32 of the secondary disc member 26. In the preferred embodiment, the outer diameter 18 of the primary disc member 12 is (6) inches and the outer diameter 32 of the secondary disc member 26 is (4) inches. The inner diameter 22 of the primary disc member is less than the inner diameter 34 of the secondary disc member 26. In the preferred embodiment, the inner diameter 22 of the primary disc member 12 is (2) inches and the inner diameter 34 of the secondary disc member 26 is (2.25) inches.

The outer diameter 18 of the primary disc member 12 forms a high shear tip 50 and the rotational speed is about 90 ft/sec creating a similar admixture velocity speed. The outer diameter 32 of the secondary disc member 26 is constructed and arranged to form a low shear tip 52 having a rotational speed of about 60 ft/sec creating a similar admixture velocity speed.

The first injection pipe 40 is positioned within a second injection pipe 42 which is a PVC tee, the first injection pipe 40 is sealed to the second injection pipe 42 by a union connection. A spring loaded check valve 60 is constructed and arranged to discharge polymer in a thin annular pattern to maximize surface contact with dilution water. The mixing impeller 10 is placed within a sealable housing 62 wherein baffle plates 64 having at least one opening 90 may be positioned outside the shearing chamber 24 to further control the shearing of the polymer. The housing 62 can consist of a base 66 to which a drive motor 70 can be attached to. Cover 72 is further attached to the base 66 by chamber rods 74 to capture housing 76 therebetween.

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A polymer mixer comprising:
a high shear member constructed from at least two spaced apart circular primary discs having a outer diameter and a first inlet formed along an inner diameter of said primary discs with a high shear chamber formed therebetween;
a low shear member constructed from at least two spaced apart circular secondary discs having an outer diameter and a second inlet formed along an inner diameter of said secondary discs with a low shear chamber formed therebetween;
at least one baffle plate having at least one opening positioned between said high shear chamber and said low shear chamber;
a first injection pipe for introducing polymer into said first inlet of said primary discs;
a second injection pipe for introducing dilution water into said inlet of said primary discs;
a drive shaft coupled to said high and low shear members for rotation;
wherein the injection of polymer and dilution water into said inlet of said primary discs during rotation forms an admixture subject to high shear mixing directed into said second inlet of said second discs for low shear mixing of said admixture.

2. The polymer mixer according to claim 1 wherein said outer diameter of said primary discs is greater than said outer diameter of said secondary discs.

3. The polymer mixer according to claim 1 wherein said inner diameter of said primary discs is less than said inner diameter of said secondary discs.

4. The polymer mixer according to claim 1 wherein said outer diameter of said primary discs is constructed and arranged to form a high shear tip.

5. The polymer mixer according to claim 4 wherein said high shear tip has a rotational speed of about 90 ft/sec creating a similar admixture velocity speed.

6. The polymer mixer according to claim 1 wherein said outer diameter of said secondary discs is constructed and arranged to form a low shear tip.

7. The polymer mixer according to claim 6 wherein said low shear tip has a rotational speed of about 60 ft/sec creating a similar admixture velocity speed.

8. The polymer mixer according to claim 1 wherein said first injection pipe is positioned within said second injection pipe.

9. The polymer mixer according to claim 1 wherein said drive shaft is rotated at 3450 rpm by an electric motor.

10. The polymer mixer according to claim 1 wherein said first and second inlets are centrally disposed concentric openings.

11. The polymer mixer according to claim 1 including multiple spaced apart discs constructed and arranged to provide multiple shear chambers having predetermined velocities.

12. The polymer mixer according to claim 1 wherein said first injection pipe includes an annular discharge spring loaded check valve, said check valve constructed and arrange to discharge polymer in a thin annular pattern to maximize surface contact with dilution water.
